(19) United States
(12) Patent Application Publication
(10) Pub. No.: US 2014/0208326 A1
(43) Pub. Date: Jul. 24, 2014

(54) FILE PRESENTING METHOD AND APPARATUS FOR A SMART TERMINAL

(71) Applicant: Tencent Technology (Shenzhen) Company Limited, Shenzhen City (CN)

(72) Inventors: Jianbao PENG, Shenzhen City (CN); Wei XIE, Shenzhen City (CN); Qi GU, Shenzhen City (CN); Yufei KUANG, Shenzhen City (CN)

(73) Assignee: Tencent Technology (Shenzhen) Company Limited, Shenzhen City (CN)

(21) Appl. No.: 14/222,955

(22) Filed: Mar. 24, 2014

Related U.S. Application Data
(63) Continuation of application No. PCT/CN2013/086785, filed on Nov. 8, 2013.

(30) Foreign Application Priority Data
Jan. 9, 2013 (CN) 201310007553.5

(51) Int. Cl. G06F 9/46

(52) U.S. Cl. CPC G06F 9/46
USPC 718/102

(57) ABSTRACT

A file presenting method and apparatus for a smart terminal is provided. The method includes determining whether it is to present a thumbnail of a file according to a type of the file, and setting loading information of the file in a loading queue if it is by a user interface thread; acquiring the loading information from the loading queue, determining whether a cache of the smart terminal stores the thumbnail of the file, generating the thumbnail of the file in accordance with the loading information and storing the generated thumbnail to the cache of the smart terminal if the cache of the smart terminal does not, and acquiring the thumbnail of the file from the cache of the smart terminal if the cache of the smart terminal does by a loading thread acquiring; presenting the thumbnail of the file as an icon of the file.

### CROSS-REFERENCE TO RELATED APPLICATIONS

The application is a U.S. continuation application of International Application PCT/CN2013/086785, with an international filing date of Nov. 8, 2013, which claims the priority benefit of Chinese Patent Application No. 201310007553.5 filed on Jan. 9, 2013, the contents of which are both being incorporated by reference herein in their entireties for all intended purposes.

### FIELD OF THE INVENTION

The disclosure relates to the field of information processing, and in particular, to a file presenting method and apparatus for a smart terminal.

### BACKGROUND

With the rapid development of computer and Internet technologies, Internet and Instant Messaging techniques play a more and more important part in usual life, learning and daily work of human being. Moreover, with the development of portable information devices, Internet also develops towards mobility. In the present information age, various information devices such as fixed phones and mobile phones for voice transmission, servers and personal computers for information resource sharing and processing, various televisions for video data display and so on, emerge as the times require. These devices are produced to solve actual requirements in particular areas. With the integration of the telecommunication network, the broadcasting network and the Internet, people pay more and more attention to the research on comprehensive utilization of the information devices in respective different areas, to provide better services to people by adequately utilizing existing devices.

“Smart terminal” is a general designation of terminals like personal computers, which have an independent operating system, can be installed programs such as software, computer games and so on provided by a third service provider by a user himself to extend the function of the terminal, and can implement network access via a communication network.

At present, the smart terminal mainly comprises the following four types: portable computer, Personal Digital Assistant, Tablet Personal Computer, and smart phone. Although some specific components of the four types of smart terminal are different, primary constituting portions of them are substantially the same.

In current file management systems of various smart terminals, the systems display respective files with default icons when a user browses a file list. Although the display of file icons can be speeded up by displaying all files with default icons, the user cannot get an overview of specific file contents while browsing the file list. As can be seen, the file browsing mode in the prior art neither facilitates the user quickly knowing about file contents nor facilitates the user swiftly locating a specific file, and thus reduces the efficiency of file browsing.

### SUMMARY OF THE INVENTION

The invention proposes a file presenting method for a smart terminal to implement fast overview of file contents by using thumbnails and thus improve the efficiency of file browsing.

The invention further proposes a file presenting apparatus for a smart terminal to implement fast overview of file contents by using thumbnails and thus improve the efficiency of file browsing.

A file presenting method for a smart terminal in accordance with an embodiment of the invention comprises: a user interface thread determining whether it is to present a thumbnail of a file according to a type of the file, and setting loading information of the file in a loading queue if it is; a loading thread acquiring the loading information of the file from the loading queue, determining whether a cache of the smart terminal stores the thumbnail of the file, generating the thumbnail of the file in accordance with the loading information of the file and storing the generated thumbnail to the cache of the smart terminal if the cache of the smart terminal does not, and acquiring the thumbnail of the file from the cache of the smart terminal if the cache of the smart terminal does; presenting the thumbnail of the file as an icon of the file.

A file presenting apparatus for a smart terminal in accordance with an embodiment of the invention comprises a loading queue setting unit, a thumbnail acquiring unit, and a thumbnail presenting unit, wherein the loading queue setting unit is used for enabling a user interface thread to determine whether it is to present a thumbnail of a file according to a type of the file, and set loading information of the file in a loading queue if it is; the thumbnail acquiring unit is used for enabling a loading thread to acquire the loading information of the file from the loading queue, determine whether a cache of the mobile phone stores the thumbnail of the file, generate the thumbnail of the file in accordance with the loading information of the file and store the generated thumbnail to the cache of the smart terminal if the cache of the smart terminal does not, and acquire the thumbnail of the file from the cache of the smart terminal if the cache of the smart terminal does; the thumbnail presenting unit is used for presenting the thumbnail of the file as an icon of the file.

As can be seen from the above technical solutions, in an embodiment of the invention, the user interface thread determines whether it is to present a thumbnail of a file according to a type of the file, and sets loading information of the file in a loading queue if it is; the loading thread acquires the loading information of the file from the loading queue, determines whether a cache of the smart terminal stores the thumbnail of the file, generates the thumbnail of the file in accordance with the loading information of the file and stores the generated thumbnail to the cache of the smart terminal if the cache of the smart terminal does not, and acquires the thumbnail of the file from the cache of the smart terminal if the cache of the smart terminal does; the thumbnail of the file is presented as an icon of the file. As can be seen, the invention implements fast overview of file contents by using thumbnails by means of a multi-thread technique and a caching mechanism and thus improves the efficiency of file browsing. Moreover, based on the setting of the caching mechanism, the invention significantly reduces the occupancy rate of the cache of the smart terminal and thus avoids the Out-Of-Memory (OOM) problem rising in the smart terminal when there are a large number of files.

### DESCRIPTION OF THE DRAWINGS

FIG. 1 is a flow diagram of a file presenting method for a smart terminal in accordance with an embodiment of the invention;

FIG. 2 is a diagram of a cooperating process of a UI thread and a loading thread in accordance with an embodiment of the invention;

FIG. 3 is a diagram of a thumbnail caching process in accordance with an embodiment of the invention;

FIG. 4 is a structural diagram of a file presenting apparatus for a smart terminal in accordance with an embodiment of the invention; and

FIG. 5 is a structure diagram of example hardware architecture of a smart terminal.

### DETAILED DESCRIPTION

In order to make the aim, the technical solutions and the advantages of the invention clearer, the invention is further described in detail below in conjunction with the accompany drawings.

In the prior art, when a user downloads files to a smart terminal by using various downloading tools, or the user desires to browse and/or edit files on the smart terminal, it is general to enter a file management interface. However, icons of all files are a unified default icon, so the user cannot get an overview of specific file contents while browsing a file list, which reduces the efficiency of file browsing.

In order to improve the efficiency of file browsing, it can be considered to replace the unified default icon with their own thumbnails for files containing certain contents. However, since pictures usually occupy memories of the smart terminal significantly, and memory resources are very precious for the smart terminal, if the display of thumbnails is implemented merely by using the memories of the smart terminal without some optimization techniques such as caching, the Out-Of-Memory (OOM) problem will readily emerge in the smart terminal when there are a large number of files.

The invention proposes a file presenting solution for a smart terminal, which implements fast overview of file contents by using thumbnails and implements fast presentation of the thumbnails by adequately using the caching mechanism.

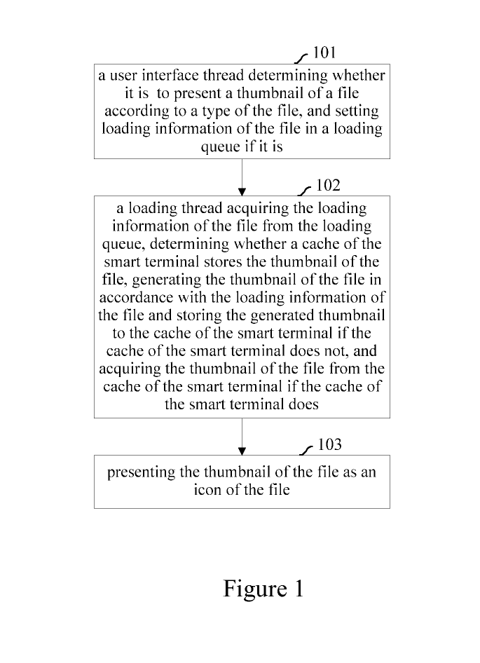

FIG. 1 is a flow diagram of a file presenting method for a smart terminal in accordance with an embodiment of the invention.

As shown in FIG. 1, the method comprises:

Step 101, a user interface (UI) thread determines whether it is to present a thumbnail of a file according to a type of the file, and sets loading information of the file in a loading queue if it is. The loading information is, for example, a storage address of the file or other information that can be used to acquire the file from a memory of the terminal.

Here, an embodiment of the invention can implement thumbnail presentation of files by using a multi-thread loading mode. Specifically, the user interface thread determines whether it is to present the thumbnail of the file according to the type of the file and sets the loading information of the file in the loading queue if it is.

In an embodiment, a picture file, a video file, an audio file, and an “apk” installment file can be set as files requiring to be presented as a thumbnail.

The person skilled in the art will recognize that although the above lists the types of files requiring to be presented as a thumbnail, the invention is not limited to these types of files. On the basis of requirements of a specific application environment, the types of files requiring to be presented as a thumbnail can be added, deleted, and/or altered.

As there can be a plurality of files requiring to be presented as a thumbnail, an embodiment of the invention further needs to set a loading queue, in which a sequence of files requiring to be presented as a thumbnail and loading information corresponding to the files are stored. The loading information of a file can be a storage address of the file, for example a storage address, in which the file is stored, in a Secure Digital Memory Card of the smart terminal.

When a user opens or slides a file management interface, the user interface thread needs to load thumbnails of files to be presented. Before loading, the loading queue that is not completed yet can be emptied, as the files that are not loaded previously do need to be displayed and thus do not need to be loaded.

In an embodiment of the invention, the user interface thread firstly acquires an index of a file to be firstly displayed, and determines whether it is to load a thumbnail of the file to be firstly displayed in accordance with the type of the file to be firstly displayed. If it is not to be loaded, the file to be firstly displayed can be presented by using a preset default icon; and if it is to be loaded, the loading information of the file to be firstly displayed is set into the loading queue. Then, the file index moves downward one position; the user interface thread determines whether a file to which the file index, after moving downward one position, directs is a file to be presented on a screen, exits the loading flow if it is not, and determines whether it is to load a thumbnail of the file to which the file index, after moving downward one position, directs in accordance with the type of the file to which the file index, after moving downward one position, directs if it is. If it is not to load, a preset default icon can be used to present the file to which the file index, after moving downward one position, directs; if it is to load, the loading information of the file to which the file index, after moving downward one position, directs is added to the loading queue. Similarly, corresponding processing is executed for files to which the file index, after continuing to move downward one or more positions, directs.

In an embodiment of the invention, the smart terminal can specifically include, but is not limited to, a feature phone, a smart phone, a personal computer (PC), a tablet personal computer, or a Personal Digital Assistant (PDA), etc.

Furthermore, the smart terminal can be adapted to any smart terminal operating system, which can specifically include, but is not limited to, Palm OS, Symbian, Windows mobile, Linux, Android, iPhone OS, Black Berry OS 6.0, or Windows Phone, etc.

In an embodiment of the invention, the smart terminal can specifically employ the Android operating system, and the smart terminal can employ respective versions of Andorid, the versions including and not limited to Android Beta, Android 1.0, Android 1.5, Android 1.6, Android 2.0/2.1, Android 2.2, Android 2.3, Android 3.0, Android 4.0, Android 4.1 and so on.

The above lists specific versions of the Android platform. The person skilled in the art will recognize that the embodiment of the invention is not limited to the above listed versions, and can also be adapted to any other version based on Android software architecture.

Step 102, a loading thread acquires the loading information of the file from the loading queue, determines whether a cache of the smart terminal stores the thumbnail of the file, generates the thumbnail of the file in accordance with the loading information of the file and stores the generated thumbnail in the cache of the smart terminal if the cache of the smart terminal does not store the thumbnail of the file, and acquires the thumbnail of the file if the cache of the smart terminal stores the thumbnail of the file.

In an embodiment of the invention, the loading thread is further set. The loading thread cooperates with the user interface thread, to present files in the smart terminal by using thumbnails.

Here, when the storage address of the file is set in the loading queue in step 101, the file can be acquired from a memory of the smart terminal according to the storage address of the file, the thumbnail of the file is generated by using a Software Development Kit (SDK), and then the generated thumbnail is stored in the cache of the smart terminal.

SDK is a set of developing tools, which are used by software development engineers to establish application software for specific software packets, software architectures, hardware platforms, operating systems and so on.

The description is made taking Android SDK as an example. Android SDK is a software development kit specific to Android. Android is a mobile phone development platform promoted by Google Corporation. Similar with iPhone, Android employs a WebKit browser engine, includes touch screen, advanced graphic display, and network surfing functions, and is a single platform incorporating all Web applications, a user capable of checking e-mails, searching network addresses, and viewing video programs on a mobile phone based on Android. Android SDK employs a Java language, so it is to install JDK 5.0 or an advanced version at first. It is more convenient to directly load and install the jdk installment document. Android SDK needs not to be installed, and can be directly decompressed after being loaded. If Eclipse is used to develop Android applications, it is to install ADT plug-ins for Eclipse. In such a way, Eclipse can establish a connection with Android SDK and initiate an Android simulator to implement program debugging. Here, the installment of ADT plug-ins is not described redundantly. A zip packet of ADT can be installed, and it is needed to make some simple configurations after plug-ins are installed.

In an embodiment, the loading thread determines whether a first level cache of the smart terminal stores the thumbnail of the file, acquires the thumbnail of the file from the first level cache of the smart terminal if the first level cache of the smart terminal stores the thumbnail of the file, further determines whether a second level cache of the smart terminal stores the thumbnail of the file if the first level cache of the smart terminal does not store the thumbnail of the file, generates the thumbnail of the file in accordance with the loading information of the file and stores the generated thumbnail to the second level cache of the smart terminal if the second level cache of the smart terminal does not store the thumbnail of the file, and acquires the thumbnail of the file if the second level cache of the smart terminal stores the thumbnail of the file.

Preferably, after generating the thumbnail of the file in accordance with the loading information of the file and storing the generated thumbnail to the second level cache of the smart terminal, the method further comprises storing the generated thumbnail to the first level cache of the smart terminal in accordance with a Recently Least Used (LRU) algorithm.

Wherein, the first level cache of the smart terminal can be a memory of the smart terminal, and the second level cache of the smart terminal can be a peripheral storage device such as a SD card of the smart terminal.

Step 103, the thumbnail of the file is presented as an icon of the file.

As it will take a period of time to present the thumbnail of the file as the icon of the file (especially the first presentation), an embodiment of the invention preferably present a preset default icon as the icon of the file before presenting the thumbnail of the file as the icon of the file. After completing the acquisition of the thumbnail of the file in accordance with the above method flow, the icon of the file is transformed from the default icon to the thumbnail of the file.

The invention can be applied to various smart terminal browsers, the browsers can specifically include Internet Explorer from Microsoft, Firefox from Mozilla, Safari from Apple, Opera, Google Chrome, GreenBrowser and so on.

Although the above specifically lists some browsers with a built-in video player of mobile terminals, the person skilled in the art will recognize that the embodiment of the invention is not limited to theses browsers, and can be adapted to any application capable of displaying files within a web server or a file system and allowing interaction between a user and a file, wherein the applications can be various common browsers or application programs having a network browsing function.

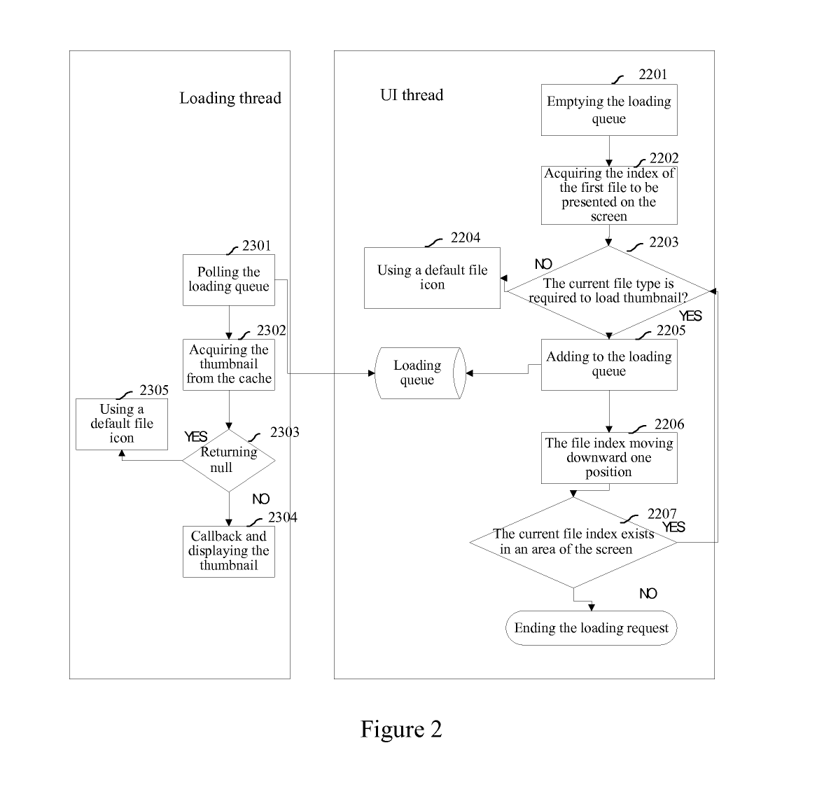

Based on the above detailed analysis, FIG. 2 is a diagram of a cooperating process of the user interface (UI) thread and the loading thread in accordance with an embodiment of the invention.

As shown in FIG. 2, the cooperating process comprises the processing logic of the loading thread and the processing logic of the user interface thread.

The processing logic of the user interface thread comprises:

S2201, emptying the loading queue.

S2202, acquiring an index of a first file to be presented on the screen.

S2203, determining whether it is to load a thumbnail of a current file in accordance with a type of the current file; if so, executing step 2205 and its subsequent steps, or else executing step 2204 and its subsequent steps.

S2204, presenting the current file by using a default icon and ending the flow.

S2205, adding the loading information of the current file to the loading queue, wherein the loading information is the storage address of the current file in the smart terminal.

Step 2206, the file index moving downward one position.

Step 2207, determining whether the index of the current file exists in an area of the screen; if so, returning to execute step 2203 and its subsequent steps, or else, ending the flow.

When the loading queue is not empty, the loading thread starts to operate. The processing logic of the loading thread comprises:

Step 2301, polling the loading queue to acquire the loading information of the file from the loading queue.

Step 2302, acquiring the thumbnail of the file from the cache of the smart terminal in accordance with the loading information of the file.

Step 2303, determining whether the acquired thumbnail of the file is null; if so, executing step 2305 and ending the flow, or else, executing step 2304 and ending the flow.

Step 2304, displaying the thumbnail of the file acquired from the cache of the smart terminal.

Step 2305, displaying the file by using a default icon.

As can be seen from the processing logic of the loading thread and the user interface thread, when the user opens or slides the file management interface, the user interface thread initially needs to load the thumbnail of the file to be displayed. The user interface thread empties the loading queue before adding the loading information to the loading queue, as thumbnails that are not loaded previously no longer need to be displayed and thus no longer need to be loaded.

The user interface thread acquires the index of the file to be firstly displayed, determines whether it is to load a thumbnail of the file to be firstly displayed in accordance with the type of the file to be firstly displayed, presents the file to be firstly displayed by using a default icon if it is not, and adding loading information of the file to be firstly displayed (mainly the storage address URL of the picture) into the loading queue if it is. The file index moves downward one position, and the user interface thread determines whether the file, to which the file index, after moving downward one position, directs is a file to be displayed on the screen, exits the flow if it is not, and repeats the loading flow the same as that for the previous file if it is.

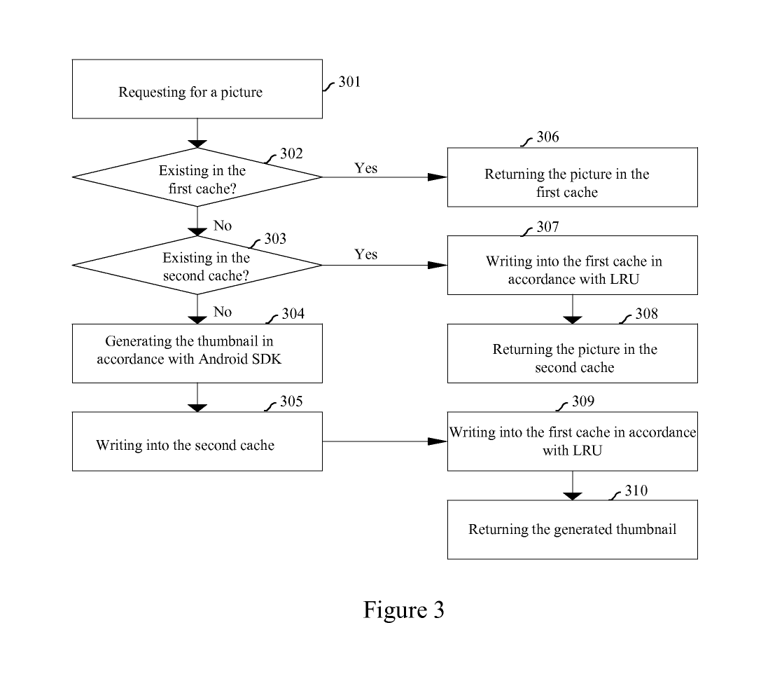

The loading thread acquires the loading information of the file, the thumbnail of which is to be loaded, from the loading queue, and invokes a cache system of the smart terminal to load (for example, see the flow shown in FIG. 3). If the cache system returns null, a default icon is used to present the file.

In an embodiment of the invention, the loading thread can use the loading information of the file (preferably, the URL of the file stored in the smart terminal) as a parameter to request for a picture (i.e., the thumbnail of the file) from the cache system of the smart terminal. The loading thread firstly requests the thumbnail of the file from a first cache (preferably a memory of the smart terminal) of the smart terminal. If the first cache contains the thumbnail matching the URL, the loading thread directly returns the thumbnail in the first cache; if the first cache does not contain the thumbnail matching the URL, the loading thread sends the request for the thumbnail to a second cache (preferably a SD card of the smart terminal). The loading thread determines whether the second cache contains the thumbnail matching the URL. If the second cache contains the thumbnail matching the URL, the loading thread writes the thumbnail into the first cache in accordance with the Recently Least Used (RLU) algorithm; if the second cache does not contain the thumbnail matching the URL, the loading thread invokes Android SDK to generate the thumbnail and writes the thumbnail into the second cache and then into the first cache in accordance with RLU.

FIG. 3 is a diagram of the thumbnail caching process in accordance with an embodiment of the invention.

As shown in FIG. 3, the thumbnail caching process comprises:

Step 301, the loading thread requesting for a picture from a cache system of the smart terminal in accordance with URL of a file stored in the smart terminal.

Step 302, determining whether a first cache of the smart terminal contains a thumbnail matching the URL; if so, executing step 306 and ending the flow, or else, executing step 303 and ending the flow.

Step 303, determining whether a second cache of the smart terminal contains the thumbnail matching the URL; if so, executing step 307 and ending the flow, or else, executing step 304 and its subsequent steps.

Step 304, the loading thread invoking Android SDK to generate the thumbnail.

S305, writing the thumbnail into the second cache and executing step 309 and its subsequent steps.

S306, returning the thumbnail in the first cache.

S307, writing the thumbnail into the first cache in accordance with LRU.

S308, returning the thumbnail in the second cache, and ending the flow.

S309, writing the generated thumbnail into the first cache in accordance with LRU.

S310, returning the generated thumbnail.

As can be known from the above detailed analysis, an embodiment of the invention further provides a file presenting apparatus for a smart terminal.

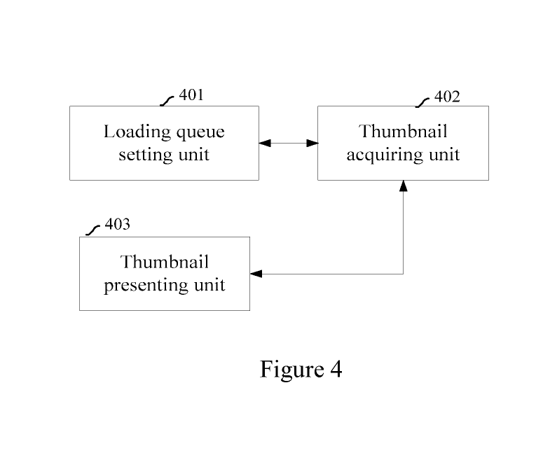

FIG. 4 is a structure diagram of the file presenting apparatus for a smart terminal in accordance with an embodiment of the invention. As shown in FIG. 4, the file presenting apparatus includes a loading queue setting unit 401, a thumbnail acquiring unit 402, and a thumbnail presenting unit 403, wherein the loading queue setting unit 401 is used for enabling a user interface thread to determine whether it is to present a thumbnail of a file in accordance with a type of the file and set loading information of the file in a loading queue if it is; the thumbnail acquiring unit 402 is used for enabling a loading thread to acquire the loading information of the file from the loading queue, determine whether a cache of the smart terminal stores a thumbnail of the file, generate the thumbnail of the file in accordance with the loading information of the file and store the generated thumbnail to the cache of the smart terminal if the cache of the smart terminal does not store the thumbnail of the file, and acquire the thumbnail of the file from the cache of the smart terminal if the cache of the smart terminal stores the thumbnail of the file; and the thumbnail presenting unit 403 is used for presenting the thumbnail of the file as an icon of the file.

In an embodiment, the loading queue setting unit 401 is used for enabling the user interface thread to set a storage address of the file in the loading queue.

The thumbnail acquiring unit 402 is used for enabling the loading thread to acquire the file in accordance with the storage address of the file, generate the thumbnail of the file by using a Software Development Kit (SDK), and store the generated thumbnail in the cache of the smart terminal.

Preferably, the thumbnail acquiring unit 402 is used for enabling the loading thread to acquire the loading information of the file from the loading queue in a polling mode.

In an embodiment, the thumbnail acquiring unit 402 is used for enabling the loading thread to determine whether a first level cache of the smart terminal stores the thumbnail of the file, acquire the thumbnail of the file from the first level cache of the smart terminal if the first level cache stores the thumbnail of the smart terminal, determine whether a second level cache of the smart terminal stores the thumbnail of the file if the first level cache does not store the thumbnail of the smart terminal, generate the thumbnail of the file according to the loading information of the file and store the generated thumbnail to the second level cache of the smart terminal if the second level cache does not store the thumbnail of the file, and acquire the thumbnail of the file from the second level cache of the smart terminal if the second level cache stores the thumbnail of the file.

In an embodiment, the thumbnail acquiring unit 402 is further used for enabling the loading thread to store the generated thumbnail in the first level cache of the smart terminal in accordance with a Least Recently Used (LRU) algorithm after enabling the loading thread to generate the thumbnail of the file in accordance with the loading information of the file and store the generated thumbnail to the second level cache of the smart terminal

In an embodiment, the thumbnail presenting unit 403 is further used for presenting a preset default icon for the file when the user interface thread determines that it is not to present the thumbnail of the file.

Preferably, the thumbnail presenting unit 403 is further used for presenting a preset default icon as the icon of the file before presenting the thumbnail of the file as the icon of the file.

Actually, the file presenting method and apparatus for a smart terminal proposed by the embodiment of the invention can be implemented in multiple forms. For example, the file presenting method for a smart terminal can be encoded as a plug-in program installed on a personal computer, a mobile phone and so on via a particular application interface conforming to a particular specification, or can be packaged as an application program for automatic loading by user. When encoded as a plug-in program, it can be implemented in multiple plug-in forms such as ocx, dll, cab and so on. The file presenting method for a smart terminal proposed by the embodiment of the invention can also be implemented by specific techniques such as Flash plug-in, RealPlayer plug-in, MMS, MIDI plug-in, Active X plug-in and so on.

The file presenting method for a smart terminal proposed by the embodiment of the invention can be stored on various storage mediums as instructions or instruction sets. The storage mediums include, but are not limited to, soft disks, optical disks, DVDs, hard disks, flash memories, U disks, CF cards, SD cards, MMC cards, SM cards, memory sticks, xD cards and so on.

Furthermore, the file presenting method for a smart terminal proposed by the embodiment of the invention can also be applied to Nand flash based storage mediums such as U disks, CF cards, SD cards, SDHC cards, MMC cards, SM cards, memory sticks, xD cards and so on.

To sum up, in an embodiment of the invention, the user interface thread determines whether it is to present a thumbnail of a file, and sets loading information of the file in a loading queue if it is; the loading thread acquires the loading information of the file from the loading queue, determines whether a cache of the smart terminal stores the thumbnail of the file, generates the thumbnail of the file in accordance with the loading information of the file and stores the generated thumbnail in the cache of the smart terminal if it is determined that the cache of the smart terminal does not store the thumbnail of the files, and acquires the thumbnail of the file from the cache of the smart terminal if it is determined that the cache of the smart terminal stores the thumbnail of the file; the thumbnail of the file is presented as an icon of the file. As can be seen, the invention implements fast overview of file contents by using thumbnails by means of a multi-thread technique and a caching scheme, and thus improves the efficiency of file browsing. Furthermore, the embodiment of the invention significantly reduces the occupancy rate of the cache of the smart terminal based on the setting of the caching scheme, and thus avoids the Out-Of-Memory problem readily emerging in the smart terminal when there are a lot of files.

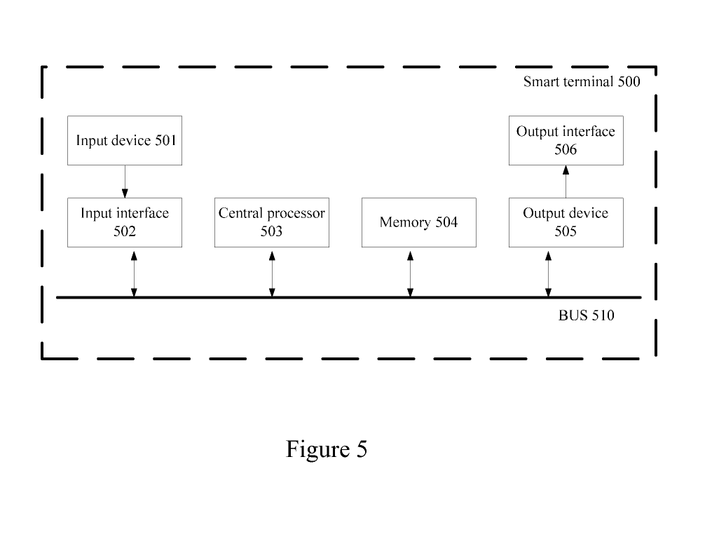

FIG. 5 is a structure diagram of example hardware architecture of a smart terminal. As shown in FIG. 5, a smart terminal 500 mainly includes an input device 501, an input interface 502, a central processor 503, a memory 504, an output interface 505, and an output device 506. The input interface 502, the central processor 503, the memory 504, and the output interface 505 are interconnected via a bus 510, and the input device 502 and the output device 506 are connected to the bus 510 via the input interface 502 and the output interface 505 respectively and then connected to other components in the smart terminal 500. Specifically, the input device 501 receives input information from external, and transmits the input information to the central processor 503 via the input interface 502; the central processor 503 processes the input information to generate output information, temporarily or persistently stores the output information in the memory 504, and then transmits the output information to the output device 506 via the output interface 505; the output device 506 outputs the output information to external of the smart terminal 500 for use by a user.

Actually, the user can establish one or more files in the smart terminal 500, or download one or more files from a network to the smart terminal 500 to form one or more file lists in the smart terminal 500. If the above described file presenting method and apparatus for a smart terminal 500 are implemented in the smart terminal 500, fast overview of file contents in the smart terminal 500 can be readily implemented by using thumbnails by means of a multi-thread technique and a caching scheme, and thus the efficiency of file browsing in the smart terminal 500 can be improved. Furthermore, the occupancy rate of the cache of the smart terminal 500 can be significantly reduced based on the setting of the caching scheme, and thus the Out-Of-Memory problem readily emerging in the smart terminal 500 can be avoided when there are a lot of files.

The above are merely prefer embodiments of the invention, and cannot be used to limit the protection scopes of the invention. Any amendment, equivalent alternative, improvement and so on within the sprite and principle of the invention shall be contained in the protection scopes of the invention.

What is claimed is:

1. A file presenting method for a smart terminal, comprising:
determining whether it is to present a thumbnail of a file according to a type of the file, and setting loading information of the file in a loading queue if it is by a user interface thread;
acquiring the loading information of the file from the loading queue, determining whether a cache of the smart terminal stores the thumbnail of the file, generating the thumbnail of the file in accordance with the loading information of the file and storing the generated thumbnail to the cache of the smart terminal if the cache of the smart terminal does not, and acquiring the thumbnail of the file from the cache of the smart terminal if the cache of the smart terminal does by a loading thread; and
presenting the thumbnail of the file as an icon of the file.

2. The file presenting method for a smart terminal of claim 1, wherein
the step of setting the loading information of the file in the loading queue comprises setting a storage address of the file in the loading queue, and
the step of generating the thumbnail of the file in accordance with the loading information of the file and storing the generated thumbnail to the cache of the smart terminal comprises:
acquiring the file from a memory of the smart terminal in accordance with the storage address of the file and generating the thumbnail of the file by using a Software Development Kit (SDK);
storing the generated thumbnail to the cache of the smart terminal.

3. The file presenting method for a smart terminal of claim 1, wherein the step of the loading thread acquiring the loading information of the file from the loading queue comprises the loading thread acquiring the loading information of the file from the loading queue in a polling mode.

4. The file presenting method for a smart terminal of claim 1, wherein the step of the loading thread determining whether the cache of the smart terminal stores the thumbnail of the file, generating the thumbnail of the file in accordance with the loading information of the file and storing the generated thumbnail to the cache of the smart terminal if the cache of the smart terminal does not, and acquiring the thumbnail of the file from the cache of the smart terminal if the cache of the smart terminal does comprises:
the loading thread determining whether a first level cache of the smart terminal stores the thumbnail of the file, acquiring the thumbnail of the file from the first level cache of the smart terminal if the first level cache of the smart terminal does, further determining whether a second level cache of the smart terminal stores the thumbnail of the file if the first level cache of the smart terminal does not, generating the thumbnail of the file in accordance with the loading information of the file and storing the generated thumbnail to the second level cache of the smart terminal if the second level cache of the smart terminal does not, and acquiring the thumbnail of the file from the second level cache of the smart terminal if the second level cache of the smart terminal does.

5. The file presenting method for a smart terminal of claim 4, wherein, after generating the thumbnail of the file in accordance with the loading information of the file and storing the generated thumbnail to the second level cache of the smart terminal, the method comprises:
storing the generated thumbnail to the first level cache of the smart terminal in accordance with a Least Recently Used (LRU) algorithm.

6. The file presenting method for a smart terminal of claim 1, wherein the method further comprises:
receiving a command to present a file management page;
emptying the loading queue.

7. The file presenting method for a smart terminal of claim 1, wherein the method further comprises:
when the user interface thread determines that it is not to present the thumbnail of the file according to the type of the file, presenting a preset default icon.

8. The file presenting method for a smart terminal of claim 1, wherein the method further comprises:
before presenting the thumbnail of the file as the icon of the file, presenting a preset default icon as the icon of the file.

9. A file presenting apparatus for a smart terminal, the apparatus comprising a loading queue setting unit, a thumbnail acquiring unit, and a thumbnail presenting unit, wherein:
the loading queue setting unit is configured to enable a user interface thread to determine whether it is to present a thumbnail of a file according to a type of the file, and set loading information of the file in a loading queue if it is;
the thumbnail acquiring unit is configured to enable a loading thread to acquire the loading information of the file from the loading queue, determine whether a cache of the smart terminal stores the thumbnail of the file, generate the thumbnail of the file in accordance with the loading information of the file and store the generated thumbnail to the cache of the smart terminal if the cache of the smart terminal does not, and acquire the thumbnail of the file from the cache of the smart terminal if the cache of the smart terminal does; and
the thumbnail presenting unit is configured to present the thumbnail of the file as an icon of the file.

10. The file presenting apparatus for a smart terminal of claim 9, wherein
the loading queue setting unit is configured to enable the user interface thread to set a storage address of the file in the loading queue;
the thumbnail acquiring unit is configured to enable the loading thread to acquire the file from a memory of the smart terminal in accordance with the storage address of the file, generate the thumbnail of the file by using a Software Development Kit (SDK), and store the generated thumbnail to the cache of the smart terminal.

11. The file presenting apparatus for a smart terminal of claim 9, wherein
the thumbnail acquiring unit is configured to enable the loading thread to acquire the loading information of the file from the loading queue in a polling mode.

12. The file presenting apparatus for a smart terminal of claim 9, wherein
the thumbnail acquiring unit is configured to enable the loading thread to determine whether a first level cache of the smart terminal stores the thumbnail of the file, acquire the thumbnail of the file from the first level cache of the smart terminal if the first level cache of the smart terminal does, further determine whether a second level cache of the smart terminal stores the thumbnail of the file if the first level cache of the smart terminal does not, generate the thumbnail of the file in accordance with the loading information of the file and store the generated thumbnail to the second level cache of the smart terminal if the second level cache of the smart terminal does not, and acquire the thumbnail of the file from the second level cache of the smart terminal if the second level cache of the smart terminal does.

13. The file presenting apparatus for a smart terminal of claim 12, wherein
the thumbnail acquiring unit is further configured to enable the loading thread to, after generating the thumbnail of the file in accordance with the loading information of the file and storing the generated thumbnail to the second level cache of the smart terminal, store the generated thumbnail to the first level cache of the smart terminal in accordance with a Least Recently Used (LRU) algorithm.

14. The file presenting apparatus for a smart terminal of claim 9, wherein
the thumbnail presenting unit is further configured to present a preset default icon when the user interface thread determines that it is not to present the thumbnail of the file.

15. The file presenting apparatus for a smart terminal of claim 9, wherein
the thumbnail presenting unit is further configured to present a preset default icon as the icon of the file before presenting the thumbnail of the file as the icon of the file.
